(19) United States
(12) Patent Application Publication
(10) Pub. No.: US 2012/0168188 A1
(43) Pub. Date: Jul. 5, 2012

(54) Portable Tool and Method for Carrying Out Work Operations with Said Tool

(75) Inventor: Martin Eckert, Neuenstein (DE)

(73) Assignee: Robert Bosch GmbH, Stuttgart (DE)

(21) Appl. No.: 13/337,082

(22) Filed: Dec. 24, 2011

(30) Foreign Application Priority Data
Dec. 29, 2010 (DE) 10 2010 056 524.5

(51) Int. Cl. B25F 5/00; B25B 21/00

(52) U.S. Cl. 173/1; 173/2

(57) ABSTRACT

A portable tool, in particular a screwing tool, has a tool head for processing a workpiece, has a drive device for driving the tool head, and has a control device for controlling the drive device, at least one work parameter of the drive device being variable. The tool has a signal detecting device, at least temporarily connected to the control device for signaling purposes, for wireless reception of signals, these signals being characteristic of at least the at least one work parameter, and the control device being fashioned in such a way that it defines the at least one work parameter in reaction to a signal detected by the signal detecting device.

This application claims priority under 35 U.S.C. §119 to patent application no. DE 10 2010 056 524.5, filed on Dec. 29, 2010 in Germany, the disclosure of which is incorporated herein by reference in its entirety.

### BACKGROUND

The present disclosure relates to a portable tool and, in particular, a portable screwing tool. Such screwing tools have recently been frequently applied in manufacturing processes. What is usually involved in this case is battery-operated portable screwing devices which, in particular, communicate with a central unit, such as a central computer. In contrast with consumer products, such professional screwing tools usually have a multiplicity of work programs for mounting screws of the most varied types. It is possible in this case to prescribe maximum torques, maximum rotational speeds, maximum angles of rotation and the like, for example.

To this end, said tools usually have a control device in which a multiplicity of such work programs are stored. In the prior art, an appropriate screwing program is usually selected manually or via a field bus. It is also possible in this case to transmit the configuration and the screwing parameters via an operating software. However, this means an increased error rate given a manual selection of the screwing program. If the configuration is transmitted via an operating software, there is a need for a PC with an operating software in order to configure and in order to input the programs.

The present disclosure therefore has an object of facilitating the assignment of specific screwing parameters or screwing programs to the respective work operations and/or the screwing operations. According to the disclosure, this is achieved by the subject matter set forth below. Advantageous embodiments and developments are also set forth below.

### SUMMARY

A portable tool according to the disclosure, in particular a screwing tool, has a tool head for processing a workpiece and, in particular, for mounting screws on this workpiece. Furthermore, the tool has a drive device for driving the tool head (or a part of the tool head such as a drive shaft), and a control device for controlling the drive device. Furthermore, in this case at least one work parameter of the drive device is variable.

According to the disclosure, the tool has a signal detecting device, at least temporarily connected to the control device for signaling purposes, for wireless reception of signals, these signals being characteristic of the at least one work parameter, and the control device being fashioned in such a way that it defines the at least one work parameter in reaction to a signal detected by the signal detecting device.

It is therefore proposed that the at least one work parameter is not made available by a control software, but is determined with the aid of said signal detecting device. The tool itself is advantageously configured via a configuration code and, in particular a configuration barcode, input in this way, and executes screwing programs which it has obtained via this code. The corresponding codes or barcodes can be produced in this case with the aid of an operating software.

The control device is advantageously fashioned such that it can select a plurality of processing programs for processing the workpiece, and it is particularly preferred for the work parameter to be characteristic of at least one of these work programs. Each work program advantageously has a prescribed set of work parameters.

In one advantageous embodiment, the signal detecting device has an optical detecting device and, in particular, a barcode scanner. It is therefore possible for said barcode to be input and for the at least one parameter, preferably a multiplicity of work parameters, to be set on the basis of this barcode. It is advantageous here for this to involve, in particular, a barcode characteristic of the respective screwing operation. It is possible in this case for the screwing programs associated with a relevant workpiece to be input directly before the screwing, the result being to decrease the risk of using wrong screwing programs. It would also be possible in this case also to transmit the appropriate information to a central unit after the relevant screwing operation in order in this way to document which screwing program has been applied for which screw. A further advantage of the inventive procedure resides in the rapid commissioning of a device or of a battery-driven screwdriver without additional operating programs.

In the case of a further advantageous embodiment, the tool has a processor device that determines the work parameter from the signal detected by the signal detecting device. It would therefore be possible, for example, to read off a specific code from a barcode and subsequently to compare said code with a code stored in a memory device, and to determine the correct work parameter in this way. However, it would also be possible to determine the respective work parameters directly from the barcode.

In a further advantageous embodiment, the tool has a rechargeable battery for its power supply.

In a further advantageous embodiment, the work parameter is selected from a group of work parameters that includes a torque of the drive device, a rotational speed of the drive device, an angle of rotation for a screwing operation, a maximum angle of rotation, an electric current, an electric voltage, combinations thereof, or the like. It is advantageous for the signal detecting device to be used to detect a plurality of signals, or a signal which is characteristic of a plurality of said work parameters. It is particularly preferred to input a set composed of work parameters which constitutes overall the abovementioned screwing program.

Furthermore, the work parameter can also be a profile of a first characteristic as a function of a further characteristic, for example a torque profile the dependent on the screwing angle. A work parameter can also be understood here as so-called screwing curves which describe the screwing operation.

In a further advantageous embodiment, the apparatus has a transmitter and/or a receiver in order to communicate with a central unit. It is therefore possible, for example, to also transmit the input parameters to said central unit so that the latter carries out a plausibility test, for example. As mentioned above, the respective work parameters actually used for a specific screwing operation can be transmitted to this central unit for documentation.

By way of example, it is possible to verify in this way whether the correct screwing program has been applied for a specific screw. If it is thus determined that a screw has been mounted with an incorrect screwing program, this can also be documented so that it is possible overall to exchange information relating to screwing operations.

The drive device is advantageously an electric motor, and preferably a servomotor. In a further advantageous refinement, the tool has at least one sensor device for detecting a work parameter such as, for example, a shaft encoder or current or voltage measuring devices, or else temperature sensors. It is also possible, in addition, to provide a comparator which compares variables detected by the servo device with the work parameters.

The present disclosure is further directed to a method for carrying out workpiece processing operations and, in particular, screwing operations, the method being carried out with a portable tool, having a tool head for processing the workpiece, a drive device for driving the tool head or at least a part of the tool head, and a control device for controlling the drive device, and at least one work parameter of the drive device being variable.

According to the disclosure, the tool uses a signal detecting device for the wireless detection of a signal which is characteristic of the work parameter, and the control device sets the work parameter a reaction to this signal.

It is therefore also proposed as regards the method to detect a signal, for example to scan in a barcode which is either itself characteristic of the work parameter, or transmits data from which the work parameter can be determined and the control device sets or resets said work parameter in reaction to this signal.

The signal is advantageously detected immediately before a work operation with the set work parameter is carried out. The risk of wrong screwing operations can be reproduced in this way.

In a further advantageous method, a work operation with the work parameter is permitted only when a period between the detection of the signal and the beginning of the work operation does not exceed a prescribed maximum value. It is ensured in this way that a screwing operation with a specific work parameter is enabled only when said work parameter has been set or amended just before the respective screwing operation.

In a further advantageous method, the signal is determined from a barcode. This means—as mentioned above—that the tool advantageously has a barcode scanner which reads out barcodes in order in this way to determine the relevant work parameter.

### BRIEF DESCRIPTION OF THE DRAWINGS

Further advantages and embodiments follow from the attached drawings, in which:

FIG. 1 shows a diagrammatic illustration of a portable tool; and

FIG. 2 shows a block diagram of an inventive apparatus.

### DETAILED DESCRIPTION

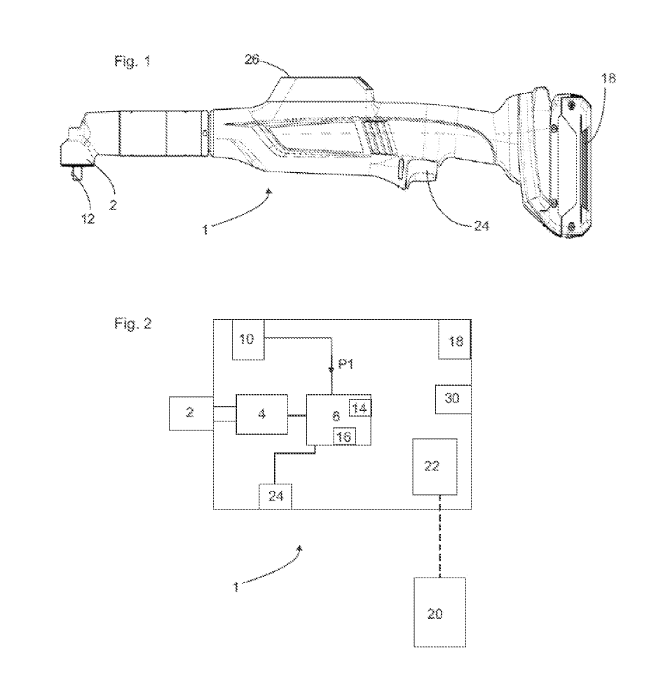

FIG. 1 shows a diagrammatic illustration of a portable tool 1. Said portable tool has in this case a tool head 2 with an output shaft 12 on which a screwing means (not shown) is arranged or can be plugged on. The tool 1 is designed here as an angular screwdriver, but it would also be possible for the tool head to be arranged rectilinearly, or pointing to the left in FIG. 1, on the tool 1. The reference symbol 24 denotes a switching device, such as a push button, with which the tool can be activated. Further switching devices can be provided on a switching area 26, for example in order to activate a scanner (not shown). The reference symbol 18 denotes a rechargeable battery which serves to operate the tool. There is also a pistol version of the screwdriver.

FIG. 2 shows a block diagram of the inventive apparatus. In this case, the reference symbol 2 refers once again to the tool head on which a screwing means can be arranged. The reference symbol 10 denotes a signal detecting device, such as a scanner here, which serves for reading out a barcode. The signals received by the signal detecting device 10 are passed on to a control device 6, this control device 6 serving to control the drive device 4, which can be a servomotor, for example.

The reference symbol 22 denotes a transceiver which can transmit signals in a wireless fashion to a central unit 20, for example a computer. In addition, the control device 6 can also have a comparator 14 which, for example, compares the work parameters P1 transmitted by the signal detecting device 10 with stored reference values in order in this way to output a suitable work program for operating the drive device 4. The signal detecting device 10 can be activated in this case via a switching device 26 (cf. FIG. 1). An appropriate barcode can be arranged, for example, on the workpiece to be handled.

It would be conceivable for there to be various sources of error associated with the inventive apparatus. Thus, for example, it would be conceivable for the user to input or scan a wrong parameter set. This can result in tightening a screw with wrong parameters or with a wrong parameter set. This, in turn, can have the effect that the threaded joint is recognizably defective and that the defective nature can be detected immediately. However, it would also be conceivable for the threaded joint actually to be successful but, for example, to have wrong parameters such as, for example, a wrong tightening torque. This could lead consequentially to defects, since such threaded connections could be too loose, too firm or not durable enough.

It would be possible in this case for each individual threaded joint or each group of similar threaded joints to have a dedicated parameter set. Thus, it would be possible for the tool to be released only for a specific time after each scanning of these parameters. In this context, the control device 6 could also have a timer 16 which is activated after each input of a parameter set and has the effect of enabling operation of the drive device 4 only for a specific time.

A further possible source of error consists in the user scanning a specific parameter set and using the latter to screw too many or not enough threaded joints. It would also be possible here for individual threaded joints to be recognizably defective, and therefore for this to be detected at once. However, it would also be possible here for some threaded joints to be tightened with a wrong tightening torque or wrong parameters, or for there to be loose screws present. This source of error could be eliminated by giving each individual threaded joint a scannable parameter set. Assignment errors could be reduced in this way.

In a further possible method, it would also be conceivable for the user firstly to scan an entire screwing cycle on the workpiece and to use this cycle also to input or determine via the control device 6 information which illustrates how many threaded joints must be made on the workpiece and, if appropriate, also the parameter sets to be used. During mounting, the user can be guided through the processing via instructions which, for example, can be output via a display 30. It is therefore advantageous for the inventive tool also to have a display 30 which preferably outputs to the user instructions relating to a particular work operation.

An acoustic operator guidance (for example via Bluetooth headset) is also conceivable.

A further possible source of error consists in the user actually scanning a specific parameter set but then not screwing a workpiece associated with said parameter set. In this case, a defective assignment of the screwing result is made to the workpiece.

A possible solution for this source of error consists in the screwdriver or the tool 1 being released only in a specific local area situated in the surroundings of the workpiece to be processed. To this end, the workpiece can, for example, have a position detecting device which determines the position of the tool in space. As mentioned above, it would also be possible after scanning to release only a specific time for a work operation or the operation of the drive device, and this would be advantageous, for example, when the data set to be scanned is located in the vicinity of the workpiece to be processed.

In the case of the embodiments shown in the figures, the work parameters are input via a barcode scanner. However, there could also be other possibilities for wireless data transmission such as, for example, inputting an RFID tag, transmitting radio or infrared signals, and the like.

The input parameters can also be passed on to the central unit 20 in order in this way also to document permanently screwing operations carried out separately.

In a further embodiment, the workpiece could also have an alarm trigger which indicates to the user when the latter is about to use a specific work program to carry out a screwing operation not suited to a said work program.

The applicant reserves the right to claim all features disclosed in the application documents if they are novel individually or in combination by comparison with the prior art.

### LIST OF REFERENCE SYMBOLS

1 Tool
2 Tool head
4 Drive device
6 Control device
10 Signal detecting device
12 Drive shaft
14 Comparator
16 Timer
18 Rechargeable battery
20 Central unit
22 Transceiver
24 Switching device
26 Switching area
30 Display
P1 Work parameter

What is claimed is:

1. A portable tool, comprising:
a tool head for processing a workpiece,
a drive device configured to drive the tool head, at least one work parameter of the drive device being variable,
a control device configured to control the drive device, and
a signal detecting device, at least temporarily connected to the control device for signaling purposes, for wireless reception of signals, these signals being characteristic of at least the at least one work parameter,
wherein the control device is fashioned in such a way that it defines the at least one work parameter in reaction to a signal detected by the signal detecting device.

2. The portable tool according to claim 1, wherein the signal detecting device has a barcode scanner.

3. The portable tool according to claim 1, further comprising a processor device configured to determine the work parameter from the signal detected by the signal detecting device.

4. The portable tool according to claim 1, further comprising a rechargeable battery for its power supply.

5. The portable tool according to claim 1, wherein the work parameter is selected from a group of work parameters that includes a torque of the drive device, a rotational speed of the drive device, an angle of rotation for a screwing operation, an electric current, an electric voltage, and combinations thereof.

6. The portable tool according to claim 1, further comprising a transmitter and/or a receiver configured to communicate with a central unit.

7. A method for carrying out workpiece processing operations with a portable tool, the tool having a tool head for processing a workpiece, a drive device for driving the tool head, at least one work parameter of the drive device being variable, a control device for controlling the drive device, and a signal detecting device, comprising:
wirelessly detecting a signal with the signal detecting device, the signal being characteristic of the work parameter, and
setting the work parameter in reaction to the signal with the control device.

8. The method according to claim 7, wherein the signal is detected immediately before a work operation with the set work parameter is carried out.

9. The method according to claim 7, further comprising:
permitting a work operation with the work parameter only when a period between the detection of the signal and the beginning of the work operation does not exceed a prescribed maximum value.

10. The method according to claim 7, wherein the signal is determined from a barcode.

11. The method according to claim 7, wherein the workpiece processing operation includes a screwing operation with the portable tool.
